(19) United States
(12) Patent Application Publication
(10) Pub. No.: US 2013/0030902 A1
(43) Pub. Date: Jan. 31, 2013

(54) System and method for providing real-time discount merchant offers

(71) Applicants: David Paschkes, Chappaqua, NY (US); Joseph W. Barnett, Locust Valley, NY (US)

(72) Inventors: David Paschkes, Chappaqua, NY (US); Joseph W. Barnett, Locust Valley, NY (US)

(21) Appl. No.: 13/559,950

(22) Filed: Jul. 27, 2012

Related U.S. Application Data
(60) Provisional application No. 61/512,209, filed on Jul. 27, 2011.

(51) Int. Cl. G06Q 30/02

(52) U.S. Cl. 705/14.35; 705/14.1; 705/14.39

(57) ABSTRACT

A method for providing consumer discount offers from a merchant using a central computer host system including defining a discount offer associated with a merchant and prescribing consumer parameters for the discount offer. Consumer demographic parameters stored in the central computer host system are analyzed with the prescribed consumer parameters to identify those consumers to whom the merchant discount offer is applicable to. The identified consumers are provided in real-time the discount offer.

### CROSS REFERENCE TO RELATED APPLICATIONS

This application claims priority to U.S. Application No. 61/512,209 filed Jul. 27, 2011, which is hereby incorporated by reference in its entirety.

### COPYRIGHT NOTICE

A portion of the disclosure of this patent document contains material which is subject to copyright protection. The copyright owner has no objection to the facsimile reproduction by any one of the patent disclosure, as it appears in the U.S. Patent and Trademark Office patent files or records, but otherwise reserves all copyright rights whatsoever.

### FIELD OF THE INVENTION

The invention generally relates to the offer and sale of goods and services, and more particularly to a system and method for providing real-time offers for goods and services of others on a network such as the internet.

### BACKGROUND OF THE INVENTION

Retailing is the exchange, sale and purchase of goods and services between a vendor or merchant and a consumer or customer. Typically, negotiation is absent between the vendor and consumer with respect to the terms of a sale or purchase of a good or service. Retailing characteristically employs a vendor-controlled format whereby the vendor determines which goods or services to offer for sale, when the goods or services will be offered for sale, and the non-negotiable fixed price at which the good or service will be sold.

Discounts are an integral part of retail strategies for many goods and services. Vendors rely upon discounts for a variety of reasons, such as to promote new and existing goods and services and to increase the sales of that particular item or service, or to increase the sales of the merchant's other goods and services. Further, consumers rely upon discounts as a way to reduce their costs.

Prior art discount techniques include providing coupons and rebates to potential customers, but these techniques have several disadvantages, such as a historically small percentage of consumer participation and fraud. Since the participation level is so small, merchants are forced to canvass an area to attract the correct demographic of potential customers for its products or services. Most of the coupons or rebates (or the advertisements containing the coupons or rebates) end up with consumers that do not need or want the goods or services.

Further, fraud is an increasing problem in that coupons may be copied, or rebates may be used to obtain cash back for goods and services that the fraudulent consumer never actually purchased.

Coupons and rebates are typically distributed using direct mail, newspaper print, and magazines and have associated with them a low percentage of users of those actually receiving the coupons. Besides not being environmentally friendly due to paper waste, coupons and rebates may not be cost effective.

Further, advertising and marketing associated with coupons and rebates can be expensive when done through radio or television medium, and extremely ineffective when done through print advertisements. Regardless of the advertising medium however, there is very little reason for the consumer to pass along the advertisement or coupon to others, so that a merchant must advertise or market the discount to each individual.

A vendor typically offers coupons or rebates in the hopes of securing future sales at full retail prices, repeat sales and ultimately an increase in overall sales.

There is currently no system and methods to mutually satisfy the consumer with a real-time discount, while at the same time providing the merchant with expense-free advertising and marketing for the goods or services. There is also no system or methods that utilize the strength of a social network to distribute information about the real-time discounts. Additionally, there exists no system and methods for providing expense-free advertising and marketing tools in addition to real-time analytics for goods and services.

### SUMMARY OF THE INVENTION

An object of the invention is to provide an computer operated system and method which facilitates a stronger sense of community by facilitating the exchange of local information and commerce such as by providing real-time targeted merchant discount offers.

It is to be appreciated local businesses typically have limited cost effective advertising and marketing vehicles to help them market their goods and services. Often, the most effective marketing tactic available to them is creating a “deal” or coupon. In the past, coupons had been a static deliverable, primarily distributed through direct mail and local papers, require planning in advance and having an associated fixed cost for distribution. Real-time market conditions such as weather, competition, daily cash flow, and the perishable nature of food and services (time) could not be taken into account and have tremendous impact to a business' profitability. Accordingly, it is an object of the present invention to provide businesses with a cost-effective solution to create unlimited offers and discounts to the local community based on these real-time conditions. Additionally, It creates a level playing field of communication and outreach to the small business community, bringing the customer's business to the most aggressive and savvy marketers.

In one aspect of the invention, a customer direct tool is provided having an intuitive interface for business' to create a detailed offer or discount and have it distributed amongst its subscribing consumers. Each merchant/business preferably determines the type of offer (discount, VIP, other), the specific value of the discount (percent off, dollar off, etc), and provides a brief description of the discount offer. Once the discount offer is confirmed by the merchant/business, it preferably gets pushed amongst its subscribing consumers. Preferably, the subscribing consumers receive discount offers through both push and pull methods. For example, subscribing consumers can request to have all business offers or select business offers sent to their email or phone via SMS in real-time. They can also go to a website to browse all offers available and choose what they want to redeem.

In another aspect of the invention provided is a system having a processor-implemented method for electronically providing consumer discount offers from a merchant, which includes providing a plurality of consumer addresses stored in the memory wherein each consumer address has associated consumer demographic data. At least one merchant offer is stored in the memory defined by offer parameters and the consumer demographic data is analyzed in a processor for each consumer address stored in the memory to determine a match with the at least one merchant offer based upon the defined offer parameters for the at least one merchant offer. The merchant offer is preferably electronically provided in real-time to each consumer address which has consumer demographic data determined to match with the at least one merchant offer based upon the defined offer parameters. It is further to be understood each merchant offer may be made for a predetermined period of time as defined by the merchant. Further, the consumer demographic data may be selected from the group consisting of consumer: age; sex; geographic location; profession; education background; marital status; income; spend preference and preferred goods and/or services, wherein the consumer demographic data may be prescribed by the consumer. The plurality of merchant offers may be stored in the memory each defined by offer parameters and wherein the analyzing step includes analyzing the consumer demographic data for each consumer address stored in the memory to determine a match with each of the stored plurality of merchant offers based upon the defined offer parameters for each of the stored plurality of merchant offers. The defined offer parameters is selected from the group consisting of: a discount to be provided; time duration of the offer; and restrictions associated with an offer. The restrictions associated with an offer may be selected from the group consisting of consumer: age; sex; geographic location; profession; education background; marital status; income and spend preference.

Yet another aspect of the invention relates to an Internet-based system for facilitating consumer discount offers, which system preferably includes a website coupled to a website server. The website server includes a memory and a plurality of consumer addresses stored in the memory wherein each consumer address has associated consumer demographic data. At least one merchant offer is stored in the memory and is defined by offer parameters. A processor is disposed in communication with the memory preferably configured to issue a plurality of instructions stored in the memory to analyze the consumer demographic data for each consumer address stored in the memory to determine a match with the at least one merchant offer based upon the defined offer parameters for the at least one merchant offer.

Thus, it is to be appreciated an advantage of the invention is it provides a business tool that addresses real-time market conditions and empowers a local business/merchant to market their products and services based on these conditions, thereby enabling the creation and testing of discounts and special offers at a cost determined by the performance of the offer.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 illustrates an exemplary computer system according to an illustrated embodiment of the invention;

FIG. 2 illustrates a flow chart in accordance with an illustrated embodiment of the invention; and

FIGS. 3-10 illustrate exemplary screen shots of the present invention.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims.

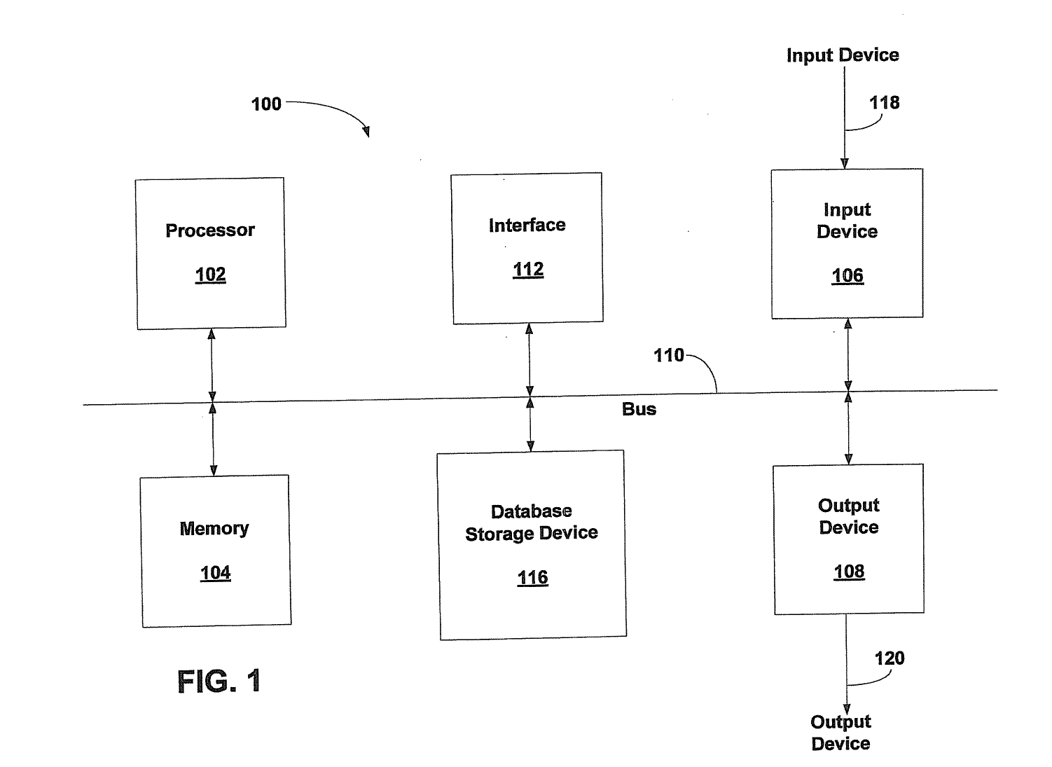

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer.

Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

With a general description of a computer system 100 provided above which is to be used, or components thereof, with the invention, discussion will now turn to an illustrated embodiment of the invention.

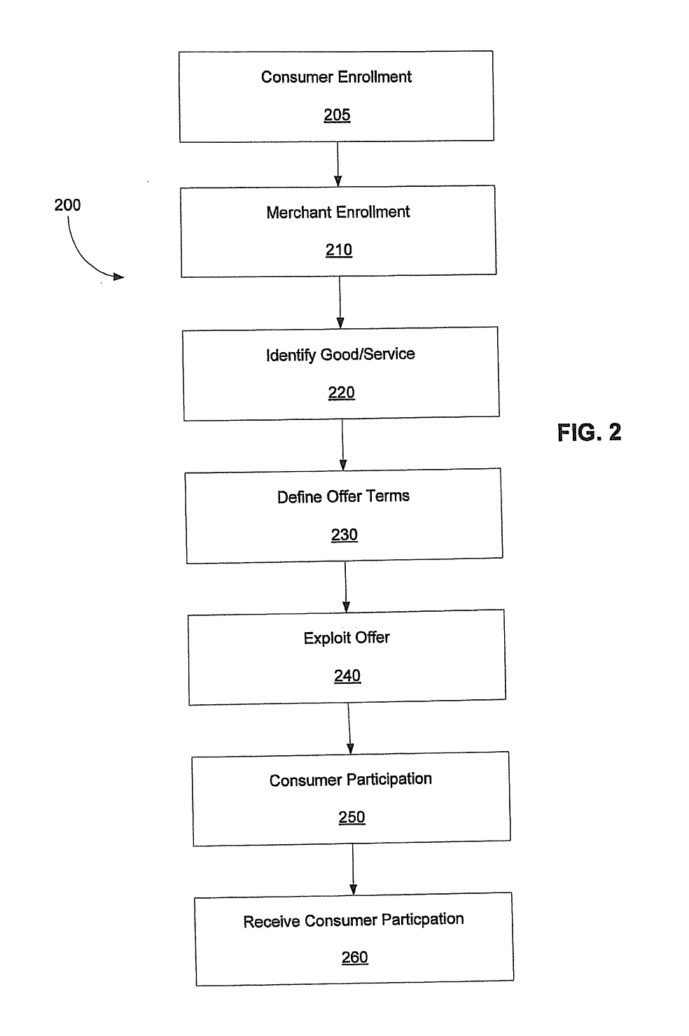

With reference now to FIG. 2, illustrated is a flow chart 200 in accordance with an illustrated embodiment of the present invention. As shown in FIG. 2, at step 205 consumers enroll with system 100 and provide customary enrollment information such as name, contact information (email, phone number, address and the like). Additionally, in accordance with an illustrated embodiment of the invention, each subscribing consumer preferably provides demographic information relating to the subscribing consumer, including, but not limited:
Age
Sex
Geographic location (e.g., Country, State, County, Town, Zipcode and the like)
Profession
School
Marital Status
Income
Spend preference
Preferred goods and/or services

This data is preferably stored in the storage device 114 of system 100, such as (but not limited to) a relational database. As indicated below, a real-time offer may be made to subscribing consumers based upon demographic information or other filtered information regarding subscribing consumers. Next, at step 210 a merchant is enrolled with system 100 for participation in the present invention discount offer system 100. Accordingly, the merchant provides the necessary information to establish an account with system 100, wherein each merchant thereafter has the ability to electronically access their account (e.g., via a website), preferably at anytime, so as to structure discount offers as further described below.

It is to be understood and appreciated the merchant may be any individual or entity (e.g., restaurant, retail store, service provide, etc.) that provides goods or services to a consumer. It is further to be understood and appreciated the merchant may be local, national or global in terms of the geography the merchant provides products or services, and the merchant may be solicited for the system 100 or may hear of the system and may approach the system's provider without being solicited. Additionally, a product or service provided by the merchant is identified for a discount offering at step 220. The aforesaid product or service may be any product sold or distributed by the merchant, and the service likewise, can be any service provided by the merchant. It is to be appreciated and understood the merchant discount offer may be offered to subscriber consumer's free of charge or for a monetary fee.

Next, at step 230, and as further elaborated below, the terms of the discount offer are determined and include a discount to be provided, duration of the offer, for example 24 hours, and maximum number, if any, of the good or service the merchant is willing to offer, expiration of the good or service, or restrictions associated with the good or service. It is to be appreciated and understood the product and/service offered for discount by the merchant (step 220) may be structured in a number of different ways including it is only offered during a predetermined time period (e.g., Monday, between 5 pm and 8 pm) and/or is only applicable to, and/or may available to, only subscribing consumers having demographics predetermined by the discount offering merchant. For instance, a merchant may structure a discount offer applicable between the hours of 8 pm and 9:30 pm on Monday and is to be made available to only females over the age of 21 who attend a certain college (e.g., Penn State). Thus, the system 100 is operative and configured to analysis the predetermined offer parameters selected by the merchant with each subscribing consumers demographic data so as to determine and identify matches between the merchant offer and the subscribing consumers. It is to be additionally appreciated and understood a merchant may structure a discount offer based upon a consumer's micro-level geographic location. For instance, an offer may be structured for consumers residing on a particular street or with a certain building address (in addition to other parameters as set forth above). Thus a merchant may structure a “get to meet your neighbor” discount offer applicable between the hours of 6 pm and 9:30 pm on a Friday and is to be made available to only consumers having a certain address (e.g., Mt. Peak Road in Chappaqua, N.Y.).

At step 240 the discount offer is exploited, through both push and pull means, to all subscribing consumers of system 100 through any known electronic communication means, such a website on the Internet, email, TXT, SMS and TMS messages, and the like. Additionally, a coupon or other information indicative of the discount offer can be caused to be printed out or visually displayed on an electronic device (e.g., cell phone, smart-phone device, tablet device, laptop and the like). Also, the offer can be presented to the merchant in the form of a code or any other type of visual indicia such as a sku, barcode, glyph or the like.

Consumers participate by accepting the offer through various means, as also described further below. At step 250, the consumer participation is received and preferably calculated in terms of the number of consumers that participated by accepting the discount offer at step 260.

Thus, what has been described is a system and method operative to provide merchant discount offers in real-time satisfying an opportunity for the merchant, which merchant discount offer is only offered to subscribing consumers having preselected demographics. For instance, a merchant may be experiencing an unexpected low volume of business whereupon the merchant can access its account on system 100 and create, in real-time, a discount offer to be made available to all, or some of the system subscribing consumers based on their demographics (as described above), which offer may be limited in time to reconcile with the unexpected low volume of business.

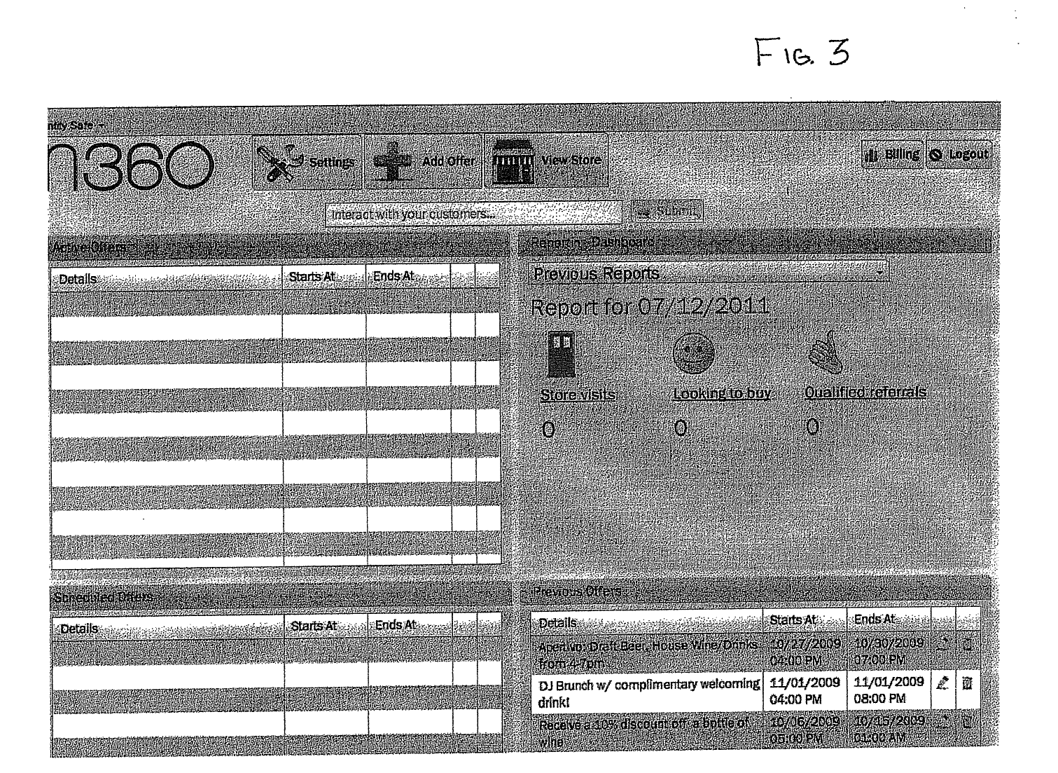

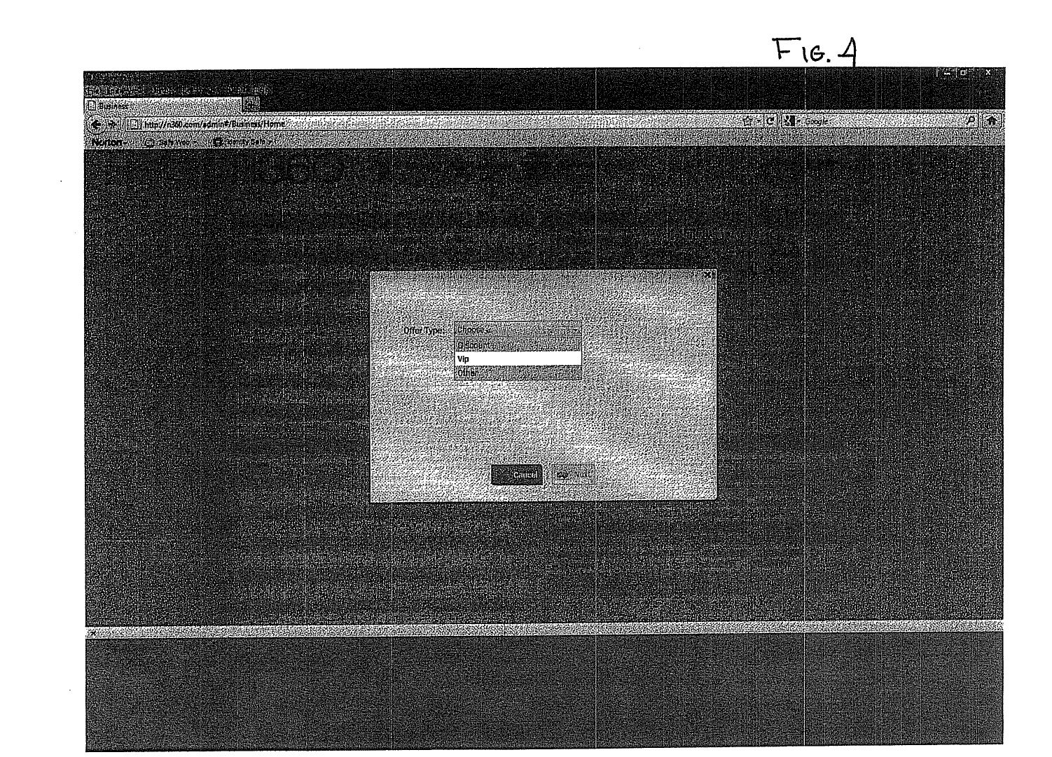

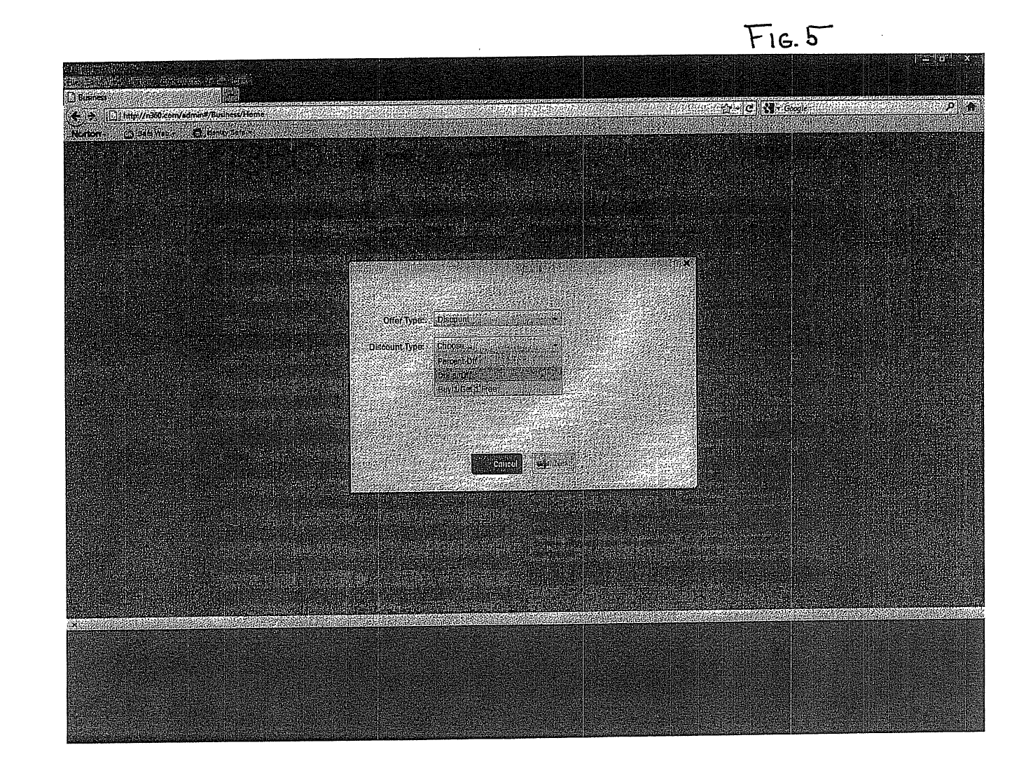

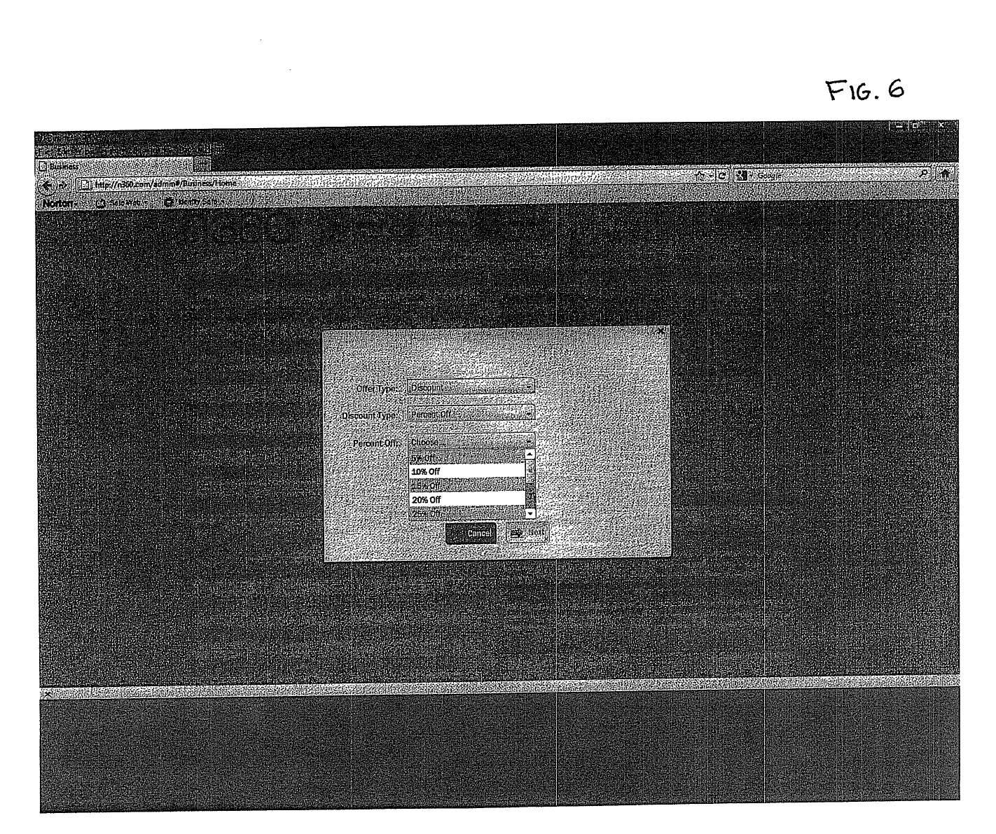

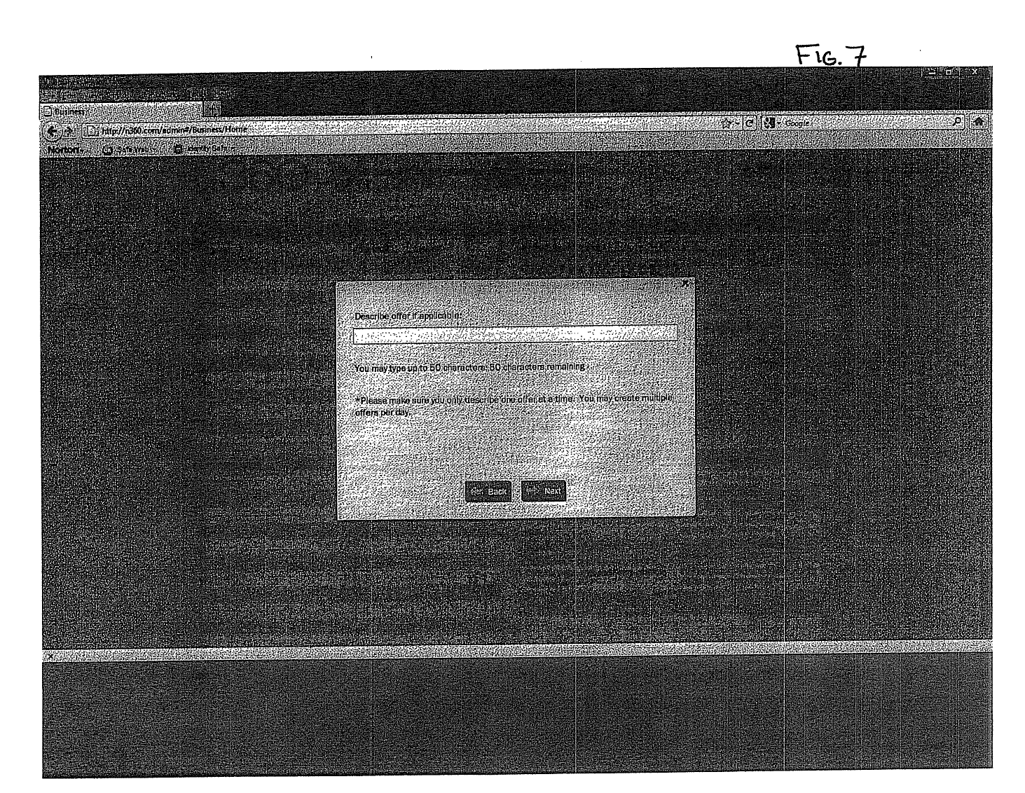

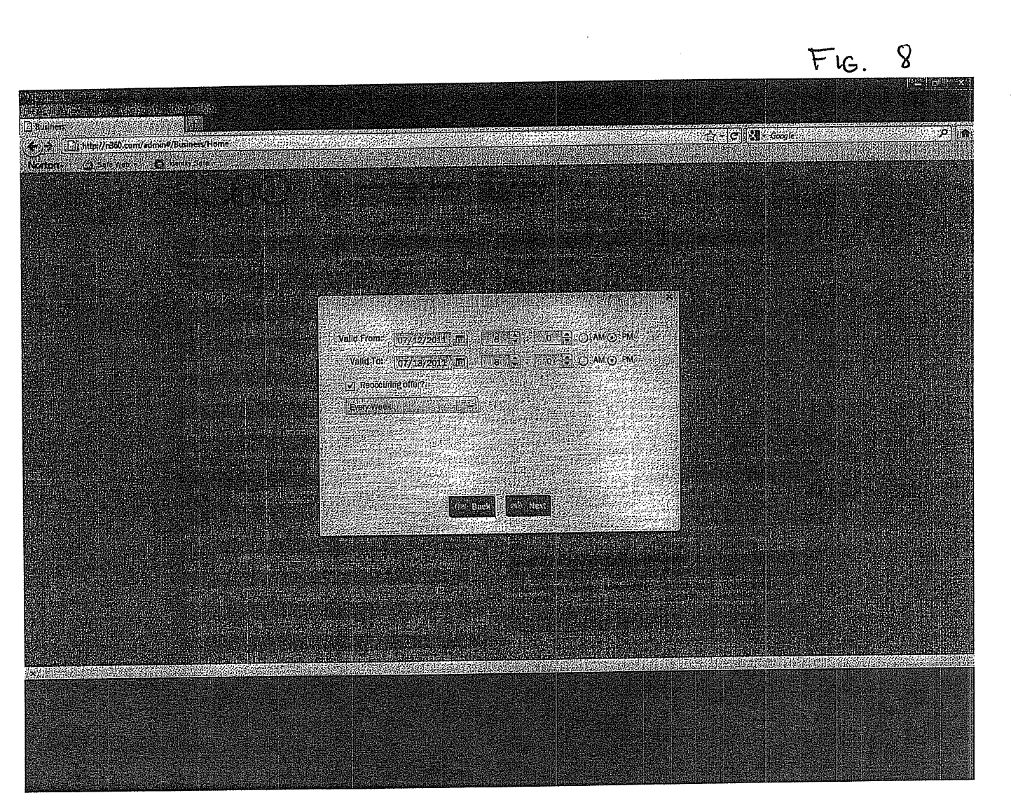

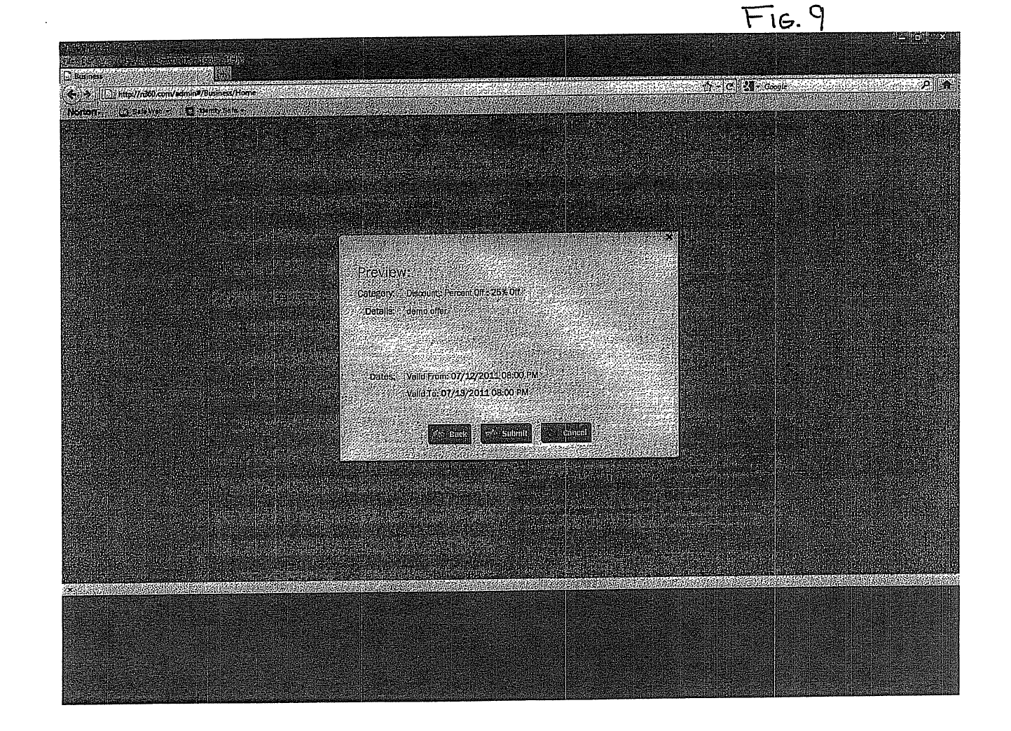

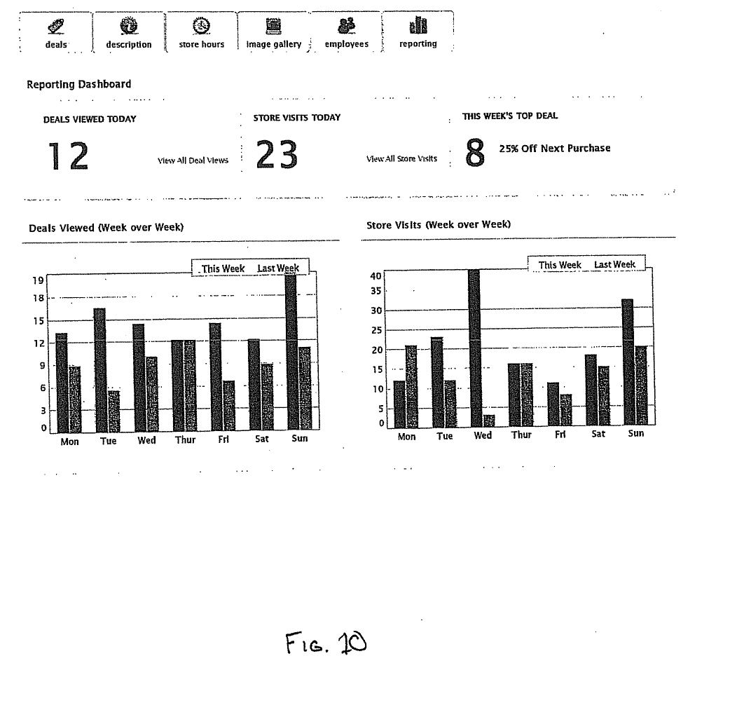

With reference now to FIGS. 3-10, shown are exemplary screen shots of the present invention. Starting at FIG. 3, shown is a Merchant's “Home” screen, operative and configured to display the merchants Active Offers, Scheduled Orders and Previous Offers. Also provided is a tool for enabling a merchant to generate a report (via the “Reporting Dashboard” section). FIG. 4 illustrates a merchant tool for defining an offer type (e.g., Discount, VIP, other). FIG. 5 illustrates a tool for defining a “Discount” offer type (e.g., Percent Off, Dollar Off, “But 1 Get One Free”, etc.) FIG. 6 illustrates a tool for defining the percentage off for a “Percent Off” offer type (e.g., 5%, 10%, 15%, 20%, etc.). FIG. 7 illustrates a tool for describing the offer (e.g., Buy 1 Soda Get One Free). FIG. 8 illustrates a tool for defining the time parameters for an offer. FIG. 9 illustrates a tool for previewing an offer. And FIG. 10 illustrates an exemplary analytical report for a merchant as generated by the present invention.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention wireless landing gear system encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A method for providing consumer discount offers from a merchant using a central computer host system, the method comprising the steps of:
defining a discount offer associated with a merchant;
prescribing consumer parameters for the discount offer;
analyzing consumer demographic parameters stored in the central computer host system with said prescribed consumer parameters to identify those consumers to whom the merchant discount offer is applicable to; and
providing in real-time the defined discount offer to the identified consumers.

2. An Internet-based system for facilitating consumer discount offers, the system comprising:
a website coupled to a website server; the website server including:
a memory
a plurality of consumer addresses stored in the memory wherein each consumer address has associated consumer demographic data;
at least one merchant offer stored in the memory defined by offer parameters;
a processor disposed in communication with the memory, and configured to issue a plurality of instructions stored in the memory, wherein the instructions issue signals to:
analyze the consumer demographic data for each consumer address stored in the memory to determine a match with the at least one merchant offer based upon the defined offer parameters for the at least one merchant offer; and
make available the at least one merchant offer via the internet to each consumer address which has consumer demographic data determined to match with the at least one merchant offer based upon the defined offer parameters.

3. An Internet-based system for facilitating consumer discount offers as recited in claim 2 wherein each merchant offer is made on a real-time basis as defined by the merchant.

4. An Internet-based system for facilitating consumer discount offers as recited in claim 2 wherein each merchant offer is made for a predetermined period of time as defined by the merchant.

5. An Internet-based system for facilitating consumer discount offers as recited in claim 2 wherein the consumer demographic data is selected from the group consisting of consumer: age; sex; geographic location; profession; education background; marital status; income; spend preference and preferred goods and/or services.

6. An Internet-based system for facilitating consumer discount offers as recited in claim 2 wherein the consumer demographic data is prescribed by the consumer.

7. An Internet-based system for facilitating consumer discount offers as recited in claim 2 wherein the consumer demographic data is defined by the website server.

8. An Internet-based system for facilitating consumer discount offers as recited in claim 2 wherein a plurality of merchant offers are stored in the memory each defined by offer parameters and wherein the processor is configured to issue instruction signals to analyze the consumer demographic data for each consumer address stored in the memory to determine a match with each of the stored plurality of merchant offers based upon the defined offer parameters for each of the stored plurality of merchant offers.

9. An Internet-based system for facilitating consumer discount offers as recited in claim 2 wherein the defined offer parameters is selected from the group consisting of: a discount to be provided; time duration of the offer and restrictions associated with an offer.

10. An Internet-based system for facilitating consumer discount offers as recited in claim 2 wherein the restrictions associated with an offer is selected from the group consisting of consumer: age; sex; geographic location; profession; education background; marital status; income and spend preference.

11. An Internet-based system for facilitating consumer discount offers as recited in claim 2 wherein the processor is configured to issue instruction signals to offer a merchant offer to a consumer only when the merchant offer satisfies defined preferred goods and/or services as predefined by the consumer in the stored consumer demographics.

12. An Internet-based system for facilitating consumer discount offers as recited in claim 2 wherein a merchant offer is made available to each consumer address which has consumer demographic data determined to match with the at least one merchant offer based upon the defined offer parameters via email.

13. A processor-implemented method for electronically providing consumer discount offers from a merchant comprising:
providing a plurality of consumer addresses stored in the memory wherein each consumer address has associated consumer demographic data;
providing at least one merchant offer stored in the memory defined by offer parameters;
analyzing the consumer demographic data in a processor for each consumer address stored in the memory to determine a match with the at least one merchant offer based upon the defined offer parameters for the at least one merchant offer; and
electronically providing in real-time the merchant offer to each consumer address which has consumer demographic data determined to match with the at least one merchant offer based upon the defined offer parameters.

14. A processor-implemented method for electronically providing consumer discount offers from a merchant as recited in claim 13 wherein each merchant offer is made for a predetermined period of time as defined by the merchant.

15. A processor-implemented method for electronically providing consumer discount offers from a merchant as recited in claim 13 wherein the consumer demographic data is selected from the group consisting of consumer: age; sex; geographic location; profession; education background; marital status; income; spend preference and preferred goods and/or services.

16. A processor-implemented method for electronically providing consumer discount offers from a merchant as recited in claim 13 wherein the consumer demographic data is prescribed by the consumer.

17. A processor-implemented method for electronically providing consumer discount offers from a merchant as recited in claim 13 wherein a plurality of merchant offers are stored in the memory each defined by offer parameters and wherein the analyzing step includes analyzing the consumer demographic data for each consumer address stored in the memory to determine a match with each of the stored plurality of merchant offers based upon the defined offer parameters for each of the stored plurality of merchant offers.

18. A processor-implemented method for electronically providing consumer discount offers from a merchant as recited in claim 13 wherein the defined offer parameters is selected from the group consisting of: a discount to be provided; time duration of the offer; and restrictions associated with an offer.

19. A processor-implemented method for electronically providing consumer discount offers from a merchant as recited in claim 13 wherein the restrictions associated with an offer is selected from the group consisting of consumer: age; sex; geographic location; profession; education background; marital status; income and spend preference.

20. A processor-implemented method for electronically providing consumer discount offers from a merchant as recited in claim 13 wherein a merchant offer is made available to each consumer address which has consumer demographic data determined to match with the at least one merchant offer based upon the defined offer parameters via email.
